(19) United States
(12) Patent Application Publication
(10) Pub. No.: US 2003/0180564 A1
(43) Pub. Date: Sep. 25, 2003

(54) Surface film for laminating on to a substrate

(76) Inventor: Torsten Marquardt, Nurnberg (DE)

Correspondence Address: HOFFMANN & BARON, LLP, 6900 JERICHO TURNPIKE, SYOSSET, NY, 11791, US

(21) Appl. No.: 10/316,196

(22) Filed: Dec. 10, 2002

(30) Foreign Application Priority Data
Dec. 14, 2001 (DE) 101 61 806.9
Dec. 21, 2001 (DE) 101 63 698.9

(51) Int. Cl. B32B 27/00

(52) U.S. Cl. 428/523; 428/500

(57) ABSTRACT

Described is a surface film 1 which is made from a cover film 2 and a base film 3 by calendering. Prior to the calendering operation a decorative layer is applied to the cover film 2. Particular advantages are achieved if the decorative layer 7 is applied by way of a film transfer process, for example by way of a hot embossing process, using a hot embossing film.

The invention concerns a surface film for application to and preferably lamination on to a substrate of plastic material, metal, wood or the like, and a process for the production of such a surface film.

DE 38 17 479 A1 discloses such a multi-layer surface film and the process for the production of such a surface film. Basically that known surface film is made from at least two separate films by lamination, more specifically from a cover film of highly transparent polyacrylate or PVDF or PVF and a base film which is colored, printed upon or has a pattern applied thereto, prior to the laminating operation. The base film comprises PMMA with an addition of PBMA for flexibilisation purposes. That material composition of the base foil gives rise to limiting boundary conditions in terms of the coloring effect, printing or patterning. A corresponding consideration also applies by virtue of the fact that the base foil which is processed for coloring or producing patterning thereon is basically joined to the separately formed cover film by way of calendering.

The object of the present invention is to provide a surface film of the kind set forth in the opening part of this specification and a process for the production of such a surface film and a process for the application of such a lamination film, which permit higher levels of design options in terms of coloring or patterning with a high degree of precision and which make it possible to have a simplified production process.

The invention attains that object by a surface film as set forth in claim 1 and a process for the production of a surface film as set forth in claim 21 and a process for the application of a surface film to a substrate as set forth in claim 28.

The first layer comprising polymers of the methacrylate group is in the form of a so-called cover film. The decorative layer is applied to that film and more specifically on the side of the film, which is towards the substrate. That therefore gives a film which can be formed as the surface film by way of calendering with one or more further films or which can be used directly as the surface film for application to and preferably lamination on to the substrate surface.

The decorative layer can be applied to the cover film by way of various processes, for example using a printing process, preferably a dry printing process, for example a digital printing process. Particular advantages are enjoyed if the decorative layer is applied to the cover film in a ‘dry’ lacquer transfer process, preferably a hot stamping or embossing process. To produce the decorative layer on the cover film the film transfer processes involve the use of a suitable transfer film or hot stamping or embossing film. This involves a transfer film which has the decorative layer in the form of a layer which comprises one or more layer portions and which is transferred on to the cover film in the transfer procedure. The film transfer process can be in the form of a ‘dry’ lacquer transfer process.

The decorative layer can be applied to the cover film in one or more successive sequential steps. When using a film transfer process, a multi-layer cover layer can be applied in a common step, by using a suitable transfer film of a multi-layer structure. Alternatively, it is also possible to implement a plurality of transfer steps in successive relationship, by a plurality of transfer films being applied to the cover film in successive steps.

The decorative layer can be in the form of a coloring layer, that is to say for example it can be suitably pigmented. As an alternative or in addition however it may also be provided with a structuring or with a single-color or multi-color pattern. There are also design configurations in which the decorative layer is in the form of an UV-stabilising layer and/or energy-absorbing layer and/or light-reflecting layer. A metal layer can also be provided on or in the decorative layer or metal pigments can be provided as components of the layer.

A high level of resistance to weathering of the surface film is achieved if there is a suitable weather-resistant protective layer. This can be in the form of a layer of the cover film, which comprises one or more layer portions. It can already be produced in various ways in production of the cover film and can for example form an integrated constituent of the cover film. The weather-resistant protective layer can however also be formed from a separate protective film which is applied to the cover film by calendering.

In the case of configurations of the surface film which comprises a cover film constructed in the above-described fashion with a decorative layer applied thereto and a base film of elasticised polymer, production of the surface film is preferably effected by calendering of that cover film provided with the decorative layer, and the base film. That affords surface films with a cover layer formed from the cover film and an intermediate layer formed by the decorative layer and a base layer formed by the base film.

The cover film can be in the form of a highly transparent layer comprising one or more layer portions. In addition the base film can also be in the form of a highly transparent layer comprising one or more layer portions. It is also possible to provide that the coloring effect is afforded exclusively by the decorative layer. In particular embodiments, it can also be provided that the cover film and/or the base film already has its own coloration, for example by means of suitable pigmentation. It is also possible to provide that the cover film and/or the base film is transparent and suitably tinted.

The cover film can be formed from PMMA and/or PMMA-blend or PMMA-coextrusion. In the case of the material comprising PMMA-blend the material can be in the form of a homogeneous mixture and the cover film can be in the form of a single-layer film consisting of that material. When using PMMA-coextrusion a plurality of layer portions can be produced by simultaneous extrusion. The cover film in that case can be in the form of a multi-layer film. The cover film can be of a preferably constant thickness in the range of between 20μ and 120μ, preferably in the range of between 40μ and 70μ.

The base film can be made from PMMA and/or PVC and/or ABS and/or PP or similar material or mixtures of materials. It can be of a preferably constant thickness in the range of between 30μ and 500μ, preferably in the range of between 40μ and 120μ.

The operation of applying a surface film which has been produced and made up in the above-described manner can be effected on a surface of a substrate comprising any material, for example plastic material, metal, wood or the like. To carry out the application operation, firstly an adhesive layer is applied to the surface of the substrate and then the surface film is applied to that adhesive layer-coated substrate surface. Alternatively or additionally an adhesive layer can be applied to the surface film and more specifically on the side of the surface film which is towards the substrate, and then the surface can be applied to the substrate.

The adhesive layer can be produced using a transparent colorless adhesive. Alternatively, it is also possible to use an opaque, preferably colored adhesive, for example a pigmented adhesive, in order to provide optical covering towards the substrate.

The surface film can also be applied in particular for external uses for example to door frames and window frames. With the relevant structure and production process it can be in the form of a particularly weather-resistant, especially heat-resistant, moisture-resistant and corrosion-resistant film. By virtue of the specific application of the decorative layer on the side of the cover film, which is towards the substrate, especially by way of a film transfer process, it is possible to embody particularly precise and varied design configurations in respect of the decorative layer.

Two embodiments of the invention are described in greater detail hereinafter with reference to drawings in which:

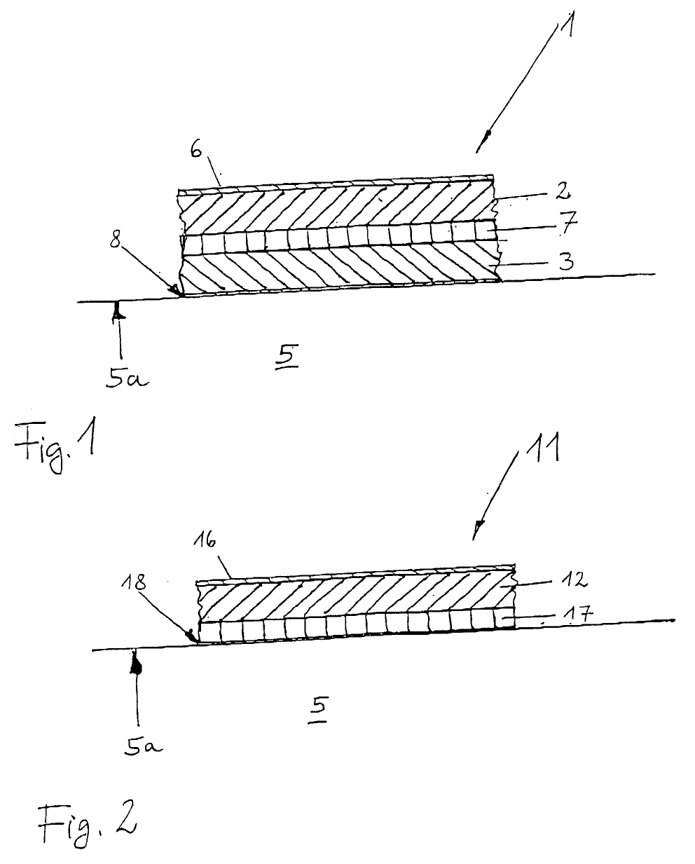

FIG. 1 is a diagrammatic view in section of a first embodiment of a surface film applied to a substrate, and

FIG. 2 is a sectional view corresponding to FIG. 1 of a second embodiment of a surface film.

In the embodiment of a surface film shown in FIG. 1 the surface film 1 comprises a cover film 2 having a decorative layer 7 and a base film 3, which are connected together by way of calendering. FIG. 1 shows the surface film 1 in a condition of being applied to a surface 5a of a substrate 5.

The cover film 2 is in the form of a film, consisting of one or more layer portions, of PMMA (polymethylmethacrylate). In the case of the film consisting of a single layer portion, the film comprises PMMA-blend, a homogeneous PMMA-mixture. In the case of the film comprising a plurality of layer portions, it comprises PMMA-coextrusion, a multi-layer film produced by simultaneous parallel extrusion. On its side remote from the substrate 5 the cover film 2 has a weather-resistant protective layer 6, preferably of PVDF (polyvinylidene fluoride). At the side towards the substrate the cover film 2 has a colored decorative layer 7. That decorative layer 7 has been applied to the relevant side of the cover film 2 prior to the operation of calendering the cover film 2 and the base foil 3. That operation of applying the cover film 2 is effected before the cover film 2 and the base foil 3 are assembled together by calendering, using the following process: the decorative layer 7 is applied to the cover film 2 by a film transfer process, for example by hot embossing. This means that the operation of applying the decorative layer 7 is effected by using a suitable transfer film which comprises a carrier film with a decorative layer 7 arranged thereon, and that decorative layer 7 is applied to the cover film by a suitable transfer procedure, more specifically by a hot embossing operation in the case of using a hot embossing film. The decorative layer 7 can be of a multi-layer nature and can be applied to the cover film in a single transfer step. It is however also possible to apply a plurality of layers in succession to the cover film 2 in respective successive transfer steps.

As an alternative to the transfer process the decorative layer 7 can also be applied to the cover film by way of other processes, for example printing processes, in particular dry printing such as digital printing.

In the illustrated embodiment the decorative layer is preferably in the form of a coloring layer. Additionally or alternatively it can also be in the form of an UV-stabilising and energy-absorbing or reflecting layer. That can be effected by the decorative layer 7 having suitable components or by suitable components being introduced into the decorative layer 7. The decorative layer 7 may also have metal pigments and metal layers and the decorative layer 7 can also be more or less transparent or tinted. It is however preferably in the form of a covering opaque layer, that is to say which is not transparent.

The base foil 3 can comprise elasticised polymer, for example PMMA (polymethylmethacrylate), PVC (polyvinylchloride), ABS (acrylonitrile/butadiene/styrene graft copolymer), PP (polypropylene) or similar material and corresponding material mixtures.

In the illustrated embodiment the surface film 1 is produced by calendering of the cover film 2 and the base film 3. The cover film 2 used has previously been provided with the cover layer 7 in accordance with the above-described process. When the cover film 2 is assembled to the base film 3 by calendering, that gives the surface film 1 which is shown in FIG. 1 and in which the decorative layer 7 forms an intermediate layer. The decorative layer 7 in the assembled condition is joined directly to the surface of the base film 3, which faces towards it.

The weather-resistant PVDF protective layer 6 forms the top side of the surface film 1. That protective layer 6 is preferably also already present on the cover film 2 in the form of a layer, with the cover foil 2 which is used here. Alternatively however that protective layer 6 can also be applied to the top side of the surface film by means of any processes, after assembly of the cover film 2 and the base foil 3. The layer 6 can also be in the form of a separate protective film which is applied to the cover film 2 or the finished surface film 1 by way of a separate calendering step.

The operation of applying the surface film 1 to the surface 5a of the substrate 5 is effected by a procedure whereby firstly a layer 8 of adhesive is applied to the substrate surface 5a and then the surface film 1 is applied by lamination thereto. Preferably rollers with metal or silicone surfaces are used in that procedure. The adhesive layer 8 can be pigmented to provide for colored covering towards the support, that is to say towards the substrate.

The surface film 11 shown in FIG. 2 differs from the surface film 1 shown in FIG. 1 in that it does not have a base film 3. The surface film 11 is applied with the decorative layer 17 of the cover film 12 directly to the adhesive layer 18 of the substrate surface 5a.

Production of the surface film 11 is effected in a corresponding manner to the embodiment in FIG. 1, in that the decorative layer 17 is applied to the cover film 12, for example by way of a transfer procedure. Alternatively, in this embodiment of FIG. 2, the decorative layer 17 can also be applied to the cover film 12 by a printing process, for example a dry printing process, in particular digital printing.

The operation of applying the cover film 11 is effected in a corresponding fashion to that described in relation to the embodiment of FIG. 1, by a procedure whereby firstly the adhesive layer 18 is applied to the substrate surface 5a and then the surface film 11 is applied by lamination. In this case the decorative layer 17 comes to bear directly on the adhesive layer 18.

1. A surface film for application to and preferably lamination on to a surface of a substrate of plastic material, metal, wood or the like, comprising
a first layer (2, 12) which comprises one or more layer portions and which is made of polymers of the methacrylate group, preferably PMMA,
a colored and/or structured decorative layer (7, 17) which comprises one or more layer portions and which is connected to the first layer (2, 12), and
preferably a weather-resistant protective layer (6, 16) which comprises one or more layer portions and which is arranged on the side of the film (1) remote from the substrate (5), preferably a PVDF layer,
characterised in that
the first layer is in the form of a cover film (2, 12), and
the decorative layer (7, 17) is in the form of a layer (7, 17) applied on the side of the cover film (2, 12) which is towards the substrate (5).

2. A surface film as set forth in claim 1 characterised in that the decorative layer (7, 17) is applied to the cover film in a printing process, preferably a dry printing process, for example a digital printing process.

3. A surface film as set forth in claim 1 characterised in that the decorative layer (7, 17) is applied to the cover film in a film transfer process, preferably a hot embossing process.

4. A surface film as set forth in claim 3 characterised in that the decorative layer (7, 17) is applied in the form of a layer, comprising one or more layer portions, of a transfer film, preferably a hot embossing film.

5. A surface film as set forth in one of the preceding claims characterised in that the decorative layer (7, 17) comprises a plurality of layers applied to the cover film (2, 12) in successive steps.

6. A surface film as set forth in one of the preceding claims characterised in that the weather-resistant protective layer (6, 16) is in the form of a layer (6, 16), comprising one or more layer portions, of the cover film (2, 12).

7. A surface film as set forth in one of claims 1 through 5 characterised in that the weather-resistant protective layer (6, 16) is formed from a protective film which is applied to the cover film (2) by assembly under pressure and/or heat and/or by calendering.

8. A surface film as set forth in one of the preceding claims characterised in that the decorative layer (7, 17) is in the form of an UV-stabilising layer and/or energy-absorbing and/or energy-reflecting layer and/or light-absorbing and/or light-reflecting layer.

9. A surface film as set forth in one of the preceding claims characterised in that the decorative layer (7, 17) has metal pigments and/or a metal layer.

10. A surface film as set forth in one of the preceding claims characterised in that the decorative layer (7, 17), on the side towards the substrate (5), is in the form of a contact surface for adhesive connection (8, 18) to the substrate (5, 5a).

11. A surface film as set forth in one of the preceding claims characterised in that arranged on the side of the decorative layer (7, 17), which is towards the substrate (5), is a base film (3) of elasticised polymer.

12. A surface film as set forth in claim 11 characterised in that the base film (3) is joined to the cover film (2) preferably by assembly under pressure and/or heat and/or by calendering.

13. A surface film as set forth in claim 12 characterised in that on its side towards the base film (3) the decorative layer (7, 17) is formed directly as a connecting surface to the base film (3).

14. A surface film as set forth in one of claims 1 through 13 characterised in that on its side towards the substrate the base film (3) is in the form of a contact surface for adhesive connection (8) on the substrate (5, 5a).

15. A surface film as set forth in one of the preceding claims characterised in that the cover film (2, 12) is of a preferably constant thickness in the range of between 20 and 120μ, preferably in the range of between 40 and 70μ.

16. A surface film as set forth in one of the preceding claims characterised in that the base film (3) is of a preferably constant thickness in the range of between 30 and 500μ, preferably in the range of between 40 and 120μ.

17. A surface film as set forth in one of the preceding claims characterised in that the cover film (2, 12) is in the form of a highly transparent layer comprising one or more layer portions.

18. A surface film as set forth in one of the preceding claims characterised in that the base film (3) is in the form of a highly transparent layer comprising one or more layer portions.

19. A surface film as set forth in one of the preceding claims characterised in that the cover film (2, 12) is formed from PMMA and/or PMMA-blend and/or PMMA-coextrusion.

20. A surface film as set forth in one of claims 12 through 19 characterised in that the base film (2) is formed from PMMA and/or PVC and/or ABS and/or PP or similar material or material mixture.

21. A process for the production of a surface film (1) which has a layer (2, 12) with a decorative layer (7, 17), in particular a surface film as set forth in one of the preceding claims, characterised in that the layer (2, 12) is formed from a cover film (2, 12) which at the side of the cover film (2, 12) facing towards the substrate is provided with a decorative layer.

22. A process as set forth in claim 21 characterised in that the decorative layer (7, 17) is applied to the cover film by a printing process, preferably dry printing, for example digital printing.

23. A process as set forth in claim 21 characterised in that the decorative layer (7, 17) is applied to the cover film (2, 12) by a film transfer process, preferably a hot embossing process.

24. A process as set forth in claim 23 characterised in that the film transfer process involves using a transfer film which has the decorative layer (7, 17) to be transferred.

25. A process as set forth in claim 24 characterised in that the transfer film used has one or more layers which in the transfer operation are transferred preferably in one operation on to the cover film (2, 12).

26. A process as set forth in claim 24 characterised in that a plurality of layers (7, 17) are applied to the cover film (2, 12) in successive sequential steps by way of transfer procedures using a plurality of transfer films.

27. A process as set forth in one of claims 21 through 26 wherein the surface film to be produced additionally has a base film, characterised in that after application of the decorative layer (7) to the cover film (2) the cover film (2) is joined to a base film (3) preferably by being assembled under pressure and/or heat and/or by calendering.

28. A process for the application of a surface film (1) produced as set forth in one of claims 21 through 27 to a surface (5a) of a substrate (5) of plastic material, metal, wood or the like, characterised in that an adhesive layer (8, 18) is applied to the surface (5a) of the substrate (5) and then the surface film (1) is applied to the surface (5a) of the substrate (5), which is provided with the adhesive layer (8, 18), and/or that an adhesive layer (8, 18) is applied to the side of the surface film (1), which is towards the substrate, and then the surface film (1) is applied with its adhesive layer to the surface (5a) of the substrate (5).

29. A process as set forth in claim 28 characterised in that to form the adhesive layer (8, 18) a pigmented adhesive is used, which provides for colored covering towards the substrate (5).
